(19) United States
(12) Patent Application Publication
(10) Pub. No.: US 2005/0016672 A1
(43) Pub. Date: Jan. 27, 2005

(54) Melt-flow controlling method for elastomer by uv irradiation

(76) Inventors: Tae-Sung Kim, Gyeonggi-do (KR); Hyuk-soo Moon, Gyeonggi-do (KR); Jong-Kul Lee, Gyeonggi-do (KR)

Correspondence Address: Christopher F Regan;Allen Dyer Doppelt Milbrath & Gilchrist, P O Box 3791, Orlando, FL, 32802-3791, US

(21) Appl. No.: 10/494,561

(22) PCT Filed: Oct. 18, 2002
(86) PCT No.: PCT/KR02/01956

(51) Int. Cl. B32B 31/00

(52) U.S. Cl. 156/275.5; 156/307.5

(57) ABSTRACT

A melt-flow controlling method for elastomer by uv irradiation for use in semiconductor packages by ultraviolet irradiation, in which a coated polymer composition is crosslinked by ultraviolet irradiation after a coating process of the polymer composition in producing the elastic adhesives. In producing the elastic adhesives for use as the thermal stress relief layer in semiconductor packages, the inventive method comprises irradiating the polymer composition with ultraviolet light of a 100-500 nm wavelength in order to control the flowability and crosslinking degree of the coated polymer composition. Thus, according to the present invention, a heating furnace is not used such that energy consumption can be reduced. Also, curing can be achieved in a short time so as to increase productivity, and the crosslinking degree is easily controlled by changing the ultraviolet dose as compared to the thermal crossliking process. Furthermore, an installation area of ultraviolet irradiation equipment is smaller than the heating furnace, and little or no epoxy reactive groups participate in the crosslinking reaction upon photo-polymerization so that the resulting film product has an excellent storage stability and thus a long life span.

### TECHNICAL FIELD

The present invention relates in general to elastic adhesives, which are used as an adhesive film in semiconductor packages. More particularly, the present invention relates to a method for controlling flowability of elastic adhesives for use in semiconductor packages by ultraviolet irradiation, in which a coated polymer composition are crosslinked by ultraviolet irradiation after a coating step of the polymer composition in producing the elastic adhesives so as to reduce flowability of the coated polymer composition.

### BACKGROUND ART

In general, as the electronic industry develops rapidly and electronic devices need to be light, thin, short and small and also to have high functionality, semiconductor devices constituting memories and drive circuits of the electronic devices are highly integrated. In addition, there is an increased demand for a method, which is capable of effectively packaging the semiconductor devices in such a manner that semiconductor packages have a small thickness and size. Semiconductor packages satisfying this demand include chip size packages (CSPs). Among CSPs, ball grid array (BGA) packages, in which solder balls are used to physically connect the semiconductor devices to a board on which the semiconductor devices are mounted, are recognized as realistic alternatives, which realize high reliability.

Micro-BGA packages, which ensure the highest level of reliability among CSPs developed till now, are adopted as a basic packaging method for a Rambus DRAM, which is a highly probable next-generation semiconductor memory.

The reason why the micro-BGA packages could have higher reliability than other packages is that elastic adhesives as a thermal stress-buffering adhesive layer was introduced in the inside of the packages. The elastic adhesives serve to delay breakdown of solder ball joints under repeated thermal conditions by relieving the thermal distortion of packages, which can be generated by the thermal expansion coefficient difference between a flex substrate and a PCB. Thus, the elastic adhesives will be widely applied even in next-generation packages.

Since Bayer AG, Germany, published a patent relating to ultraviolet-curable unsaturated polyesters, scientific or practical studies on an ultraviolet irradiation crosslinking method has attracted attention throughout the world. However, application fields of these unsaturated polyesters are limited to wood furniture, household goods and other several fields.

In a prior package process, the elastic adhesives are adhered to a substrate at a high temperature of 150-200° C. under a pressure of 1-1.5 MPa. In this case, there is a disadvantage in that the elastic adhesives excessively flow due to the pressure used in the adhering step so that circuits or leads are contaminated, thereby causing electrical defects. Thus, in order to minimize a flow of the elastic adhesives, a crosslinking process is required in producing the elastic adhesives.

A prior process for crosslinking the elastic adhesives is a thermal curing process using a heating furnace. A coating resin composition used in producing the elastic adhesives comprises a polymer resin having epoxy reactive groups to provide adhesive strength, a rubber resin to provide a low-elastic property, various additives, and a suitable solvent to dissolve the resins.

In the prior art, in order to obtain the elastic adhesives of desired physical properties from the coating resin composition, the coating resin composition was passed through a plurality of heating furnaces so as to crosslink the composition after the solvent was removed. Namely, heat is used as an energy source for the curing reaction, thereby causing polymerization of the epoxy reactive groups.

The thermal curing process according to the prior art has various advantages, including wide uses and easy operations, but it has the following problems.

Namely, since the thermal curing process according to the prior art employs a plurality of heat sources, it requires much energy and cost. Also, since the heating furnace as curing equipment has a large size, a large installation area is required. Moreover, since a curing time ranges from several minutes to several hours, productivity is reduced. Furthermore, since it is difficult to obtain an adhesive property if reactivity of the epoxy groups is high, the polymerization reaction needs to be minutely controlled. In addition, since the epoxy reactive groups partially participate in the crosslinking reaction, the storage stability and thus life span of the resulting products are reduced.

### DISCLOSURE OF INVENTION

Accordingly, the present invention has been made to solve the above-mentioned problems occurring in the prior art, and an object of the present invention is to provide a method for controlling flowability of elastic adhesives for use in semiconductor packages by ultraviolet irradiation, in which a coated polymer composition is irradiated with ultraviolet light of a 100-500 nm wavelength in producing the elastic adhesives for use as a thermal stress relief layer in semiconductor packages in order to control the flowability and crosslinking degree of the coated polymer composition, so that a heating furnace is not used so as to reduce energy consumption, curing can be achieved in a short time so as to increase productivity, the crosslinking degree is easily controlled by controlling a dose of ultraviolet light as compared to the thermal crosslinking process, an installation area of ultraviolet irradiation equipment is smaller than the heating furnace, and little or no epoxy reactive groups participate in the crosslinking reaction upon photo-polymerization so that the resulting product has an excellent storage stability and thus a long life span.

To achieve the above-mentioned object, the present invention provides a method for controlling flowability of elastic adhesives by ultraviolet irradiation, which comprises the steps of coating a substrate with a light curable polymer composition to a desired thickness to form an adhesive film; drying the resulting structure; forming a lamination film on the adhesive film of the substrate, thereby forming a three-layered elastic adhesive film consisting of the substrate, the adhesive film and the lamination film; irradiating the elastic adhesive film with ultraviolet light; and photo-polymerizing the adhesive film while adjusting ultraviolet dose, at the ultraviolet irradiation step.

Also, in the method of the present invention, the substrate is a peelable transparent film. The ultraviolet dose, which is applied to the elastic adhesive film per unit area and unit time, is controlled by controlling the movement speed of the elastic adhesive film with a rotating roll and controlling a dose of light from an ultraviolet lamp. As the ultraviolet lamp, there are used an arc type lamp, which emits ultraviolet light by heat generation, and a fusion type lamp, which emits ultraviolet light by a generated electromagnetic wave. These lamps are used alone or in combination. The adhesive film contains a photo-polymerization initiator and a substance participating in the photo-polymerization. Examples of the photo-polymerization initiator, which can be used in the practice of the present invention, include 1-hydroxy hexyl phenyl ketone, 2-hydroxy-2-methyl-1-phenylpropane-1-one, 4-(2-hydroxyethyl)phenyl-(2-hydroxy-2-methylpropyl)ketone, phosphite oxide, cyclopentadienyl phenyl iron hexafluoro phosphate, diphenylketone, bis(2,6-dimethoxybenzoyl)-dibutyl-2-methylethyl phosphine oxide, bis(2,4,6-trimethoxybenzoyl)phenyl phosphine oxide, and a combination thereof, and the like. Examples of the substances participating in the photo-polymerization, which can be used in the practice of the present invention, include acrylonitrile-butadiene copolymer, acrylonitrile-butadiene-styrene copolymer, acrylonitrile-butadiene-methylmethacrylate copolymer, acrylonitrile-butadiene-n-butylacrylate copolymer, and a combination thereof, and the like, each of which contains diacrylate monomer and unsaturated hydrocarbons. Also, other examples of the substance participating in the photo-polymerization include hydrogenated acrylonitrile-butadiene copolymer, hydrogenated acrylonitrile-butadiene-styrene copolymer, hydrogenated acrylonitrile-butadiene-methylmethacrylate-silicon copolymer, and a combination thereof, and the like, each of which contains unsaturated hydrocarbons at low concentration.

### BRIEF DESCRIPTION OF THE DRAWINGS

FIG. 1 shows an elastic adhesive film, which was dried before ultraviolet irradiation but after coating of a polymer composition according to the present invention;

FIG. 2 is a schematic view, which illustrates the method of the present invention in which the elastic adhesive film of FIG. 1 is irradiated with ultraviolet light; and

FIG. 3 is a flow chart, which illustrates the method of the present invention in which an elastic adhesive film is irradiated with ultraviolet light.

### BEST MODE FOR CARRYING OUT THE INVENTION

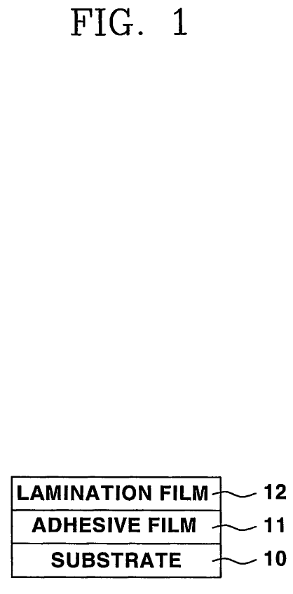

FIG. 1 is a cross-sectional view showing a three-layered elastic adhesive film, which was dried after coating of a polymer composition. Referring to FIG. 1, the elastic adhesive film consists of the substrate 10, the adhesive film 11 and the lamination film 12. The production of the three-layered film, which was dried after coating of a polymer composition, can be achieved in one process in a coating machine.

According to the present invention, in producing elastic adhesives for use as an adhesive film for semiconductor packages, the elastic adhesive film is irradiated with ultraviolet light after the coating step of the polymer composition in order to reduce flowability of the elastic adhesives. The present invention concerns the improvement of the elastic adhesive structure by ultraviolet light.

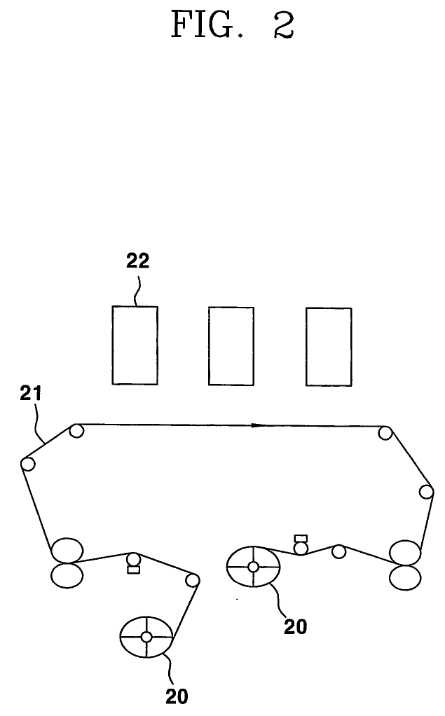

FIG. 2 is a schematic view, which illustrates the method of the present invention in which the elastic adhesive film of FIG. 1 is irradiated with ultraviolet light. In FIG. 2, there are shown the ultraviolet lamp 22, the rotating roll 20 and the elastic adhesive film 21. More concretely, ultraviolet light used in the ultraviolet irradiation step has a wavelength of 100-500 nm. Moreover, it is efficient to use the ultraviolet lamp 22, which emits the highest dose of light at a wavelength of 200-350 nm.

As the ultraviolet lamp 22 used for ultraviolet irradiation, there are used an arc type lamp, which emits ultraviolet light by the generation of heat, and a fusion type lamp, which generates an electromagnetic wave using a device such as a magnetron and emits ultraviolet light by the generated electromagnetic wave. These lamps are used alone or in combination.

In irradiating the three-layered elastic adhesive film 21 with ultraviolet light, a dose of ultraviolet light from the ultraviolet lamp 22 and a rotating speed of the rotating roll 20 are controlled so that a dose of ultraviolet light applied to the elastic adhesive film 21 per unit area and unit time are changed. Thus, the degree of reaction of a polymerization initiator contained in the elastic polymer film can be adjusted so that the crosslinking degree and flowability of the elastic adhesive film 21 can be minutely adjusted.

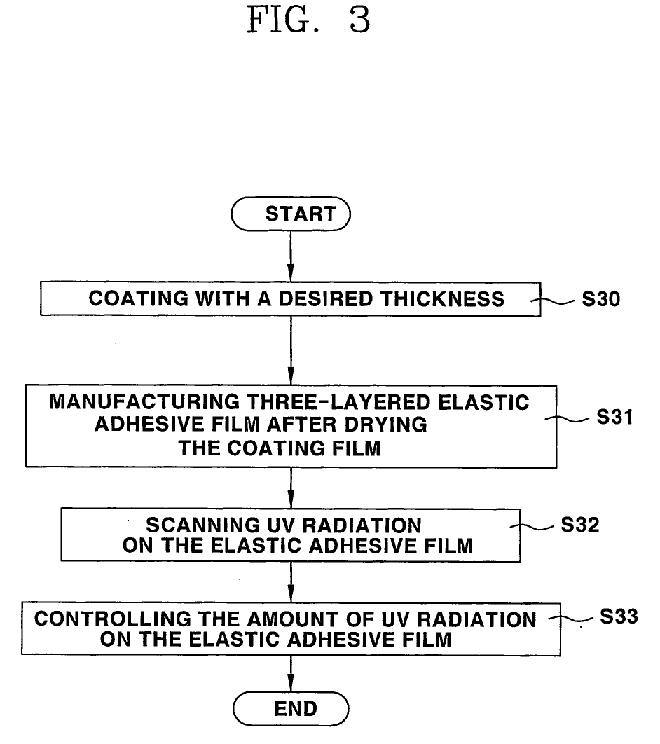

FIG. 3 is a flow chart illustrating the method of the present invention in which the elastic adhesive film is irradiated with ultraviolet light.

As shown in FIG. 3, a light curable polymer composition is coated on a peelable film having an excellent ultraviolet light transmission to a desired thickness using a blade coating method, a gravure coating method or an extrusion coating method, and then dried, thereby producing a three-layered elastic adhesive film consisting of the substrate 10, the adhesive film 11 and the lamination film 12 (Step S30 and Step S31).

Immediately after the coating step was completed, the formed elastic adhesive film 21 is irradiated with ultraviolet light in a state where the elastic adhesive film 21 continuously moves at a constant speed. At this time, the moving speed of the elastic adhesive film 21 is adjusted with the rotating roll 20 and a dose of ultraviolet light from the ultraviolet lamp 22 is changed, so that the light dose applied to the elastic adhesive film 21 per unit area and unit time can be adjusted, and thus, the flowability of the elastic adhesive film can be minutely adjusted (Step S31 and Step S32).

Meanwhile, the light-curable polymer composition used for the production of the elastic adhesive film must contain unsaturated hydrocarbons such that it can be radically polymerized in the initiation, propagation and termination reaction.

The ultraviolet-absorbing peak of the photo-polymerization initiator contained in the polymer composition must be corresponded with the wavelength of light from the ultraviolet lamp. The elastic adhesive film has a relatively large thickness of about 175 μm. Thus, as the photo-polymerization initiator, there is preferably used 1-hydroxy hexyl phenyl ketone, 2-hydroxy-2-methyl-1-phenylpropane-1-one, 4-(2-hydroxyethyl)phenyl-(2-hydroxy-2-methylpropyl)ketone, phosphite oxide, cyclopentadienyl phenyl iron hexafluoro phosphate, diphenylketone, bis(2,6-dimethoxybenzoyl)-dibutyl-2-methylethyl phosphine oxide, bis(2,4,6-trimethoxybenzoyl)phenyl phosphine oxide, or a combination thereof, or the like, which has an excellent ultraviolet absorbing property.

As substances participating in the photo-polymerization using the photo-polymerization initiator, there is used acrylonitrile-butadiene copolymer, acrylonitrile-butadiene-styrene copolymer, and acrylonitrile-butadiene-methylmethacrylate polymer, acrylonitrile-butadiene-n-butylacrylate copolymer, or a combination thereof, or the like, which contains light-polymerizable diacrylate monomer and unsaturated hydrocarbons. In this case, if the concentration of unsaturated hydrocarbons is too high, the substrate can then get damaged due to exothermic polymerization reaction. For this reason, as substances participating in the photo-polymerization, there is more preferably used hydrogenated acrylonitrile-butadiene copolymer, hydrogenated acrylonitrile-butadiene-styrene copolymer, hydrogenated acrylonitrile-butadiene-methylmethacrylate-silicon copolymer, or a combination thereof or the like, which contains unsaturated hydrocarbons at relatively low concentration.

In this photo-polymerization step, the epoxy reactive groups hardly participate in the reaction. This could be proved from the result of a Differential Scanning Calorimetry (DSC) test, which was carried out using the elastic adhesives according to the present invention and the elastic adhesives produced according to the thermal curing process. This suggests that the elastic adhesives according to the present invention have excellent adhesive strength and storage stability.

Properties of the elastic adhesives according to the present invention will now be described in detail with reference to the following examples.

First, in a flowability test, a flow of the elastic adhesives was measured using an adhering machine for elastic adhesives at 160° C. under 2 MPa for 18 seconds. The sample used in the measurement had a size of 10 mm×20 mm. In this case, an average flow of the sample flowed in a direction perpendicular to the 20 mm edge portion was taken as a flow of the elastic adhesives. As a result, the flow of the elastic adhesives was less than 300 μm, which indicated a good result.

In an adhesive strength test, the elastic adhesive was adhered on a polyimide film as a substrate using an adhering machine for elastic adhesives at 160° C. under 2 MPa for 2 seconds. Then, the adhesive strength of the elastic adhesives was measured according to the T-peel test. As a result, the measured adhesive strength was 1500 g/cm, which was 300 g/cm greater than the elastic adhesives produced according to the thermal curing process.

In order to test storage stability of the elastic adhesives after vacuum packing of the elastic adhesives was undone, a change in the adhesive strength of the elastic adhesives according to the passage of time was measured. Where the elastic adhesives were left to stand at less than 5° C., a reduction in their adhesive strength did not occur till six months. Even when the elastic adhesives were left to stand at room temperature, a reduction in their adhesive strength was insignificant as compared to the elastic adhesives according to the thermal curing process.

Also, immediately after the elastic adhesives were produced, a Differential Scanning Calorimetry (DSC) test was carried out for the elastic adhesives according to the present invention and the elastic adhesives according to the thermal curing process. As a result, the elastic adhesives according to the present invention exhibited a caloric value of more than 100 joule/g at the peak of epoxy reaction, which was greater than 60-70 joule/g of the elastic adhesives according to thermal curing process. This indicates that little or no epoxy reactive groups participated in the photo-polymerization reaction.

As described above, in producing the elastic adhesives for use in semiconductor packages, the present invention comprises irradiating the elastic adhesive film with ultraviolet light after the coating step in a state where the elastic adhesive film continuously moves at a constant speed. The movement speed of the elastic adhesive film is adjusted with the rotating roll, so that the ultraviolet dose received by the elastic adhesive film per unit area and unit time can be changed and thus minutely adjusted. As the ultraviolet lamp, which emits ultraviolet light, there are used the arc type lamp, which emits ultraviolet light by heat generation, and the fusion type lamp, which generates the electromagnetic wave using devices such as the magnetron and emits ultraviolet light by the generated electromagnetic wave. These lamps are used alone or in combination.

Meanwhile, the light curable polymer composition used to form the elastic adhesive film, which is then irradiated with ultraviolet light, must contain unsaturated hydrocarbons. As the photo-polymerization initiator contained in this composition, there is used 1-hydroxy hexyl phenyl ketone, 2-hydroxy-2-methyl-1-phenylpropane-1-one, 4-(2-hydroxyethyl)phenyl-(2-hydroxy-2-methylpropyl)ketone, phosphite oxide, cyclopentadienyl phenyl iron hexafluoro phosphate, diphenylketone, bis(2,6-dimethoxybenzoyl)-dibutyl-2-methylethyl phosphine oxide, bis(2,4,6-trimethoxybenzoyl)phenyl phosphine oxide, or a combination thereof or the like, which has an excellent ultraviolet absorbing property.

The polymer composition contains the substance, which participates in the photo-polymerization using the photo-polymerization initiator. If the concentration of unsaturated hydrocarbons in the polymer composition is too high, the substrate can then get damaged due to exothermic polymerization reaction. For this reason, as the substances participating in the photo-polymerization, there is preferably used hydrogenated acrylonitrile-butadiene copolymer, hydrogenated acrylonitrile-butadiene-styrene copolymer, hydrogenated acrylonitrile-butadiene-methylmethacrylate-silicon copolymer, or a combination or the like.

### INDUSTRIAL APPLICABILITY

As described above, according to the present invention, in producing the elastic adhesives for use as the thermal stress relief layer for semiconductor packages, the elastic adhesive film is irradiated with ultraviolet light of a 100-500 nm wavelength in order to control the flowability and crosslinking degree of the coated polymer composition. Thus, in the present invention, the heating furnace is not used such that energy consumption can be reduced. Also, curing can be achieved in a short time so as to increase productivity, and the crosslinking degree is easily controlled by changing the ultraviolet dose as compared to the thermal crossliking process. Furthermore, an installation area of ultraviolet irradiation equipment is smaller than the heating furnace, and little or no epoxy reactive groups participate in the crosslinking reaction upon photo-polymerization so that the resulting film product has an excellent storage stability and thus a long life span. In addition, the ultraviolet-crosslinked elastic adhesive film according to the present invention is excellent in adhesive strength, storage stability and flowability, as compared to the prior elastic adhesives produced according to the thermal curing process.

1. A melt-flow controlling method for elastomer by uv irradiation, which comprises the steps of:
coating a substrate with a light curable polymer composition to a desired thickness to form an adhesive film;
drying the resulting structure;
forming a lamination film on the adhesive film of the substrate, thereby forming a three-layered elastic adhesive film consisting of the substrate, the adhesive film and the lamination film;
irradiating the elastic adhesive film with ultraviolet light; and
photo-polymerizing the adhesive film while adjusting ultraviolet dose, at the ultraviolet irradiation step.

2. The method of claim 1, wherein the substrate is a peelable transparent film.

3. The method of claim 1, wherein the ultraviolet dose is adjusted by adjusting the movement speed of the elastic adhesive film with a rotating roll and adjusting the dose of light from an ultraviolet lamp, so that the ultraviolet dose, which is applied to the elastic adhesive film per unit area and unit time, is adjust.

4. The method of claim 3, wherein the ultraviolet lamp is selected from the group consisting of an arc type lamp, which emits ultraviolet light by heat generation, and a fusion type lamp, which emits ultraviolet light by a generated electromagnetic wave, and a combination thereof.

5. The method of claim 1, wherein the adhesive film contains a photo-polymerization initiator and a substance participating in the photo-polymerization.

6. The method of claim 5, in which the photo-polymerization initiator is selected from the group consisting of 1-hydroxy hexyl phenyl ketone, 2-hydroxy-2-methyl-1-phenylpropane-1-one, 4-(2-hydroxyethyl)phenyl-(2-hydroxy-2-methylpropyl)ketone, phosphite oxide, cyclopentadienyl phenyl iron hexafluoro phosphate, diphenylketone, bis(2,6-dimethoxybenzoyl)-dibutyl-2-methylethyl phosphine oxide, bis(2,4,6-trimethoxybenzoyl)phenyl phosphine oxide, and a combination thereof.

7. The method of claim 5, in which the substance participating in the photo-polymerization is selected from the group consisting of acrylonitrile-butadiene copolymer, acrylonitrile-butadiene-styrene copolymer, acrylonitrile-butadiene-methylmethacrylate copolymer, acrylonitrile-butadiene-n-butylacrylate copolymer, and a combination thereof.

8. The method of claim 5, in which the substance participating in the photo-polymerization is selected from the group consisting of hydrogenated acrylonitrile-butadiene copolymer, hydrogenated acrylonitrile-butadiene-styrene copolymer, hydrogenated acrylonitrile-butadiene-methylmethacrylate-silicon copolymer, and a combination thereof.
